(19) United States
(12) Patent Application Publication
(10) Pub. No.: US 2007/0094695 A1
(43) Pub. Date: Apr. 26, 2007

(54) Video audio display device

(75) Inventor: Satoru Naka, Tsurugashima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/585,184

(22) Filed: Oct. 24, 2006

(30) Foreign Application Priority Data
Oct. 24, 2005 (JP) 2005-308937

(51) Int. Cl. H04N 7/173

(52) U.S. Cl. 725/100; 725/131

(57) ABSTRACT

According to one embodiment, there is provided a video audio display device including: a receiving section that receives a broadcast program to output an audio signal and an video signal, the broadcast program including rating information; a speaker unit that receives the audio signal and generates a sound according to the audio signal; a display unit that receives the video signal and displays an image according to the video signal; a rating read unit that reads the rating information of the broadcast program; a block section that blocks a generation of the sound and a display of the image based on the rating information; a timer that counts a time; and a control section that release a parental control to block the generation of the sound and the display of the image based on the rating information according to the time counted in the timer.

### CROSS-REFERENCE TO RELATED APPLICATIONS

This application is based upon and claims the benefit of priority from Japanese Patent Application No. 2005-308937, filed Oct. 24, 2005, the entire contents of which are incorporated herein by reference.

### BACKGROUND

1. Field

One embodiment of the invention relates to a video audio display device and, more particularly, to a video audio display device incorporating a timer.

2. Description of the Related Art

In the United States, etc., the V-CHIP controller is employed as one of parental controls. In a television set, and the like, the V-CHIP unit is used by a supervisor (parent, or the like) to restrict the program or video audio, which is watched by the supervised person (child, or the like), with reference to rating information about the content of a broadcast program or a video content. The V-CHIP is a part that reads rating information superposed on the broadcast program or the video content and then outputs a result.

The V-CHIP controller decides whether or not the program or the video audio should be restricted, based on the compared result between the result and a rating being set previously in the V-CHIP controller and then allows to output the program or the video audio based on the decision result or does not allow.

Some types of the V-CHIP controller incorporate timers. For example, the system set forth in JP-T-2003-519974 discloses such a system that, when the supervisor sets the rating different from a usual rating, such rating returns to the original rating after the timer counts up to a predetermined time. However, JP-T-2003-519974 does not disclose that the rating is cleared in the system after a predetermined time is counted in the timer. In addition, since clearing the rating information is performed temporarily within an idea that is applied to set the rating different from the usual rating, usability of the system is limited.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a main signal processing system of a digital television broadcast receiver according to embodiments of the invention;

FIG. 2 is an example of a parental control set screen of a video audio display device according to Embodiment 1;

FIG. 3 is an example of a time set screen of the video audio display device according to Embodiment 1;

FIG. 4 is a process flowchart of an example of a timer decrement of the video audio display device according to Embodiment 1;

FIG. 5 is an example of screen when a rating block is released in the video audio display device according to Embodiment 1 after a time has elapsed or by an input of the password;

FIG. 6 is an example of a password input screen of the video audio display device according to Embodiment 1; and

FIG. 7 is an exemplary process flowchart of an input of the password when a parental control is performed according to Embodiment 1.

### DETAILED DESCRIPTION

Various embodiments according to the invention will be described hereinafter with reference to the accompanying drawings. In general, according to one embodiment of the invention, there is provided a video audio display device including: a receiving section that receives a broadcast program to output an audio signal and an video signal, the broadcast program including rating information; a speaker unit that receives the audio signal and generates a sound according to the audio signal; a display unit that receives the video signal and displays an image according to the video signal; a rating read unit that reads the rating information of the broadcast program; a block section that blocks a generation of the sound and a display of the image based on the rating information; a timer that counts a time; and a control section that release a parental control to block the generation of the sound and the display of the image based on the rating information according to the time counted in the timer.

[Embodiment 1]

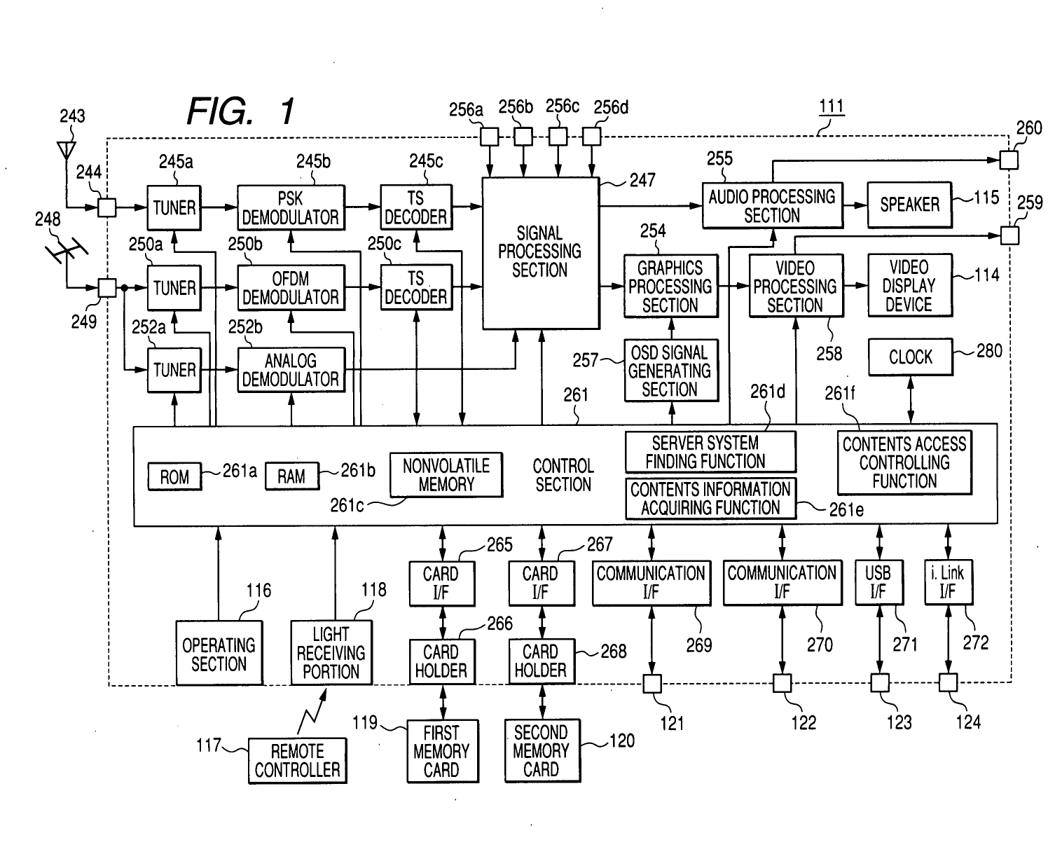

FIG. 1 shows a main signal processing system of a digital television broadcast receiver 111 according to embodiments.

That is, a satellite digital television broadcast signal received by a BS/CS digital broadcast receiving antenna 243 is sent to a satellite digital broadcast tuner 245a through an input terminal 244.

The tuner 245a selects a broadcast signal on a desired channel based on a control signal from a control section 261. Then, the tuner 245a outputs the selected broadcast signal to a PSK (Phase Shift Keying) demodulator 245b.

The PSK demodulator 245b demodulates the broadcast signal selected by the tuner 245a, based on the control signal from the control section 261. Then, the PSK demodulator 245b obtains a transport stream containing a desired program and output the transport stream to a TS decoder 245c.

The TS decoder 245c performs a TS decoding process of a transport stream (TS) multiplex signal based on a control signal from the control section 261. Then, the TS decoder 245c outputs digital video signals and digital audio signals of the desired program to a signal processing section 247, and also outputs various data (service information) to acquire the program fed through the digital broadcast, electronic program guide (EPG) information, program attribute information (program genre, and the like), subtitles information, and so on to the control section 261.

Also, a digital terrestrial television broadcast signal received by a terrestrial broadcast receiving antenna 248 is supplied to a digital terrestrial broadcast tuner 250a through an input terminal 249.

The tuner 250a selects a broadcast signal on a desired channel based on the control signal from the control section 261. Then, the tuner 250a outputs the selected broadcast signal to an OFDM (Orthogonal Frequency Division Multiplexing) demodulator 250b.

The OFDM demodulator 250b demodulates the broadcast signal selected by the tuner 250a, based on the control signal from the control section 261. Then, the OFDM demodulator 250b obtains a transport stream containing the desired program and output the transport stream to a TS decoder 250c.

The TS decoder 250c performs a TS decoding process of the transport stream (TS) multiplex signal based on the control signal from the control section 261. Then, the TS decoder 250c outputs the digital video signals and the digital audio signals of the desired program to the signal processing section 247, and also outputs various data to acquire the program fed through the digital broadcast, electronic program guide (EPG) information, program attribute information (program genre, and the like), etc. to the control section 261.

Also, an analog terrestrial television broadcast signal received by the terrestrial broadcast receiving antenna 248 is supplied to an analog terrestrial broadcast tuner 252a through the input terminal 249, so that the broadcast signal on the desired channel is selected. Then, the broadcast signal selected by this tuner 252a is supplied to an analog demodulator 252b and demodulated into analog video signals and analog audio signals, and then output to the signal processing section 247.

Here, as the general function, the signal processing section 247 applies selectively predetermined digital processes to the digital video signals and the digital audio signals supplied from the PSK demodulator 245b and the OFDM demodulator 250b respectively, and then outputs the processed signals to a graphics processing section 254 and an audio processing section 255.

Also, a plurality of (four in the illustration) input terminals 256a, 256b, 256c and 256d are connected to the signal processing section 247. The analog video signals and the analog audio signals can be input through these input terminals 256a, 256b, 256c and 256d from the outside of a digital television broadcast receiver 111 respectively.

The signal processing section 247 selectively digitizes the analog video signals and the analog audio signals supplied from the analog demodulator 252b and the input terminals 256a, 256b, 256c and 256d respectively. Then, the signal processing section 247 applies predetermined digital signal processes to the digitized video and audio signals, and then outputs the processed signals to the graphics processing section 254 and the audio processing section 255. A timer 247b is built in the signal processing section 247.

The graphics processing section 254 has a function of superposing the digital video signal supplied from the signal processing section 247 on the OSD signal generated by an OSD (On Screen Display) signal generating portion 257. The graphics processing section 254 can output selectively the video signal output from the signal processing section 247 and the OSD signal output from the OSD signal generating section 257, and can output both outputs in combination to constitute a half of the screen respectively.

Also, when subtitles are displayed by a subtitled broadcast, the graphics processing section 254 performs a process of superposing subtitles information on the video signal, based on the control signal from the control section 261 and the subtitles information.

The digital video signal output from the graphics processing section 254 is supplied to a video processing section 258. The video processing section 258 converts the input digital video signal into the analog video signal in a format that can be displayed on a video display device 114. Then, the video processing section 258 outputs the video signal to the video display device 114 to display such video signal, and outputs the video signal to the outside via an output terminal 259.

Also, the audio processing section 255 converts the input digital audio signal into the analog audio signal in a format that can be reproduced by a speaker 115. Then, the audio processing section 255 outputs the analog audio signal to the speaker 115 to reproduce the audio, and outputs the audio signal to the outside through an output terminal 260.

Here, all operations of the digital television broadcast receiver 111 containing various receiving operations are controlled on the whole by the control section 261. The control section 261 has CPU (Central Processing Unit), or the like therein. This control section 261 receives operation information sent out from an operating section 116 or receives operation information sent out from a remote controller 117 through a light receiving portion 118, and controls respective portions to reflect the operation contents.

In this case, the control section 261 utilizes mainly a ROM (Read Only Memory) 261a for storing control programs that the CPU executes, a RAM (Random Access Memory) 261b for providing a working area to the CPU, and a nonvolatile memory 261c for storing various set information, control information, and the like.

Also, the control section 261 is connected to a card holder 266, to which a first memory card 119 can be fitted, through a card I/F (interface) 265. Thus, the control section 261 can perform information exchange with the first memory card 119 fitted to the card holder 266, through the card I/F 265.

In addition, the control section 261 is connected to a card holder 268, to which a second memory card 120 can be fitted, through a card I/F 267. Thus, the control section 261 can perform information exchange with the second memory card 120 fitted to the card holder 268, through the card I/F 267.

Also, the control section 261 is connected to a first LAN terminal 121 through a communication I/F 269. Thus, the control section 261 can perform information exchange with respective LAN-enabled devices connected to the first LAN terminal 121, through the communication I/F 269.

Further, the control section 261 is connected to a second LAN terminal 122 through a communication I/F 270. Thus, the control section 261 can perform information exchange with respective devices connected to the second LAN terminal 122, through the communication I/F 270.

Also, the control section 261 is connected to a USB terminal 123 through a USB I/F 271. Thus, the control section 261 can perform information exchange with respective devices connected to the USB terminal 123, through the USB I/F 271.

Moreover, the control section 261 is connected to an i.Link terminal 124 through an i.Link I/F 272. Thus, the control section 261 can perform information exchange with respective devices (see FIG. 1) connected to the i.Link terminal 124, through the i.Link I/F 272.

Also, the control section 261 has (1) a server system finding function 261d, (2) a contents information acquiring function 261e, and (3) a contents access control function 261f.

(1) According to the server system finding function 261d, the control section 261 finds the UPnP-enabled device on the network by using a discovery function of the UpnP. (2) According to the contents information acquiring function 261e, the control section 261 controls the UPnP-enabled device by using a control function of the UPnP, and acquires URI information required to access the contents in the UPnP-enabled device.

(3) According to the contents access control function 261f, the control section 261 decides whether or not the access to the contents is enabled, based on IP address information of the server device acquired by the server system finding function 261d, IP address information derived from URI information acquired by the contents information acquiring function 261e, IP address allocated to the LAN terminal 122 of the digital television broadcast receiver 111, and net masks. When the control section 261 decides that the access to the contents is enabled, the control section 261 permits the concerned device to access the contents. In contrast, when the control section 261 does not decide that the access to the contents is enabled, the control section 261 causes the video display device 114 to display the effect that the access is not enabled, by using OSD. The timer 247b may be built in the control section 261.

FIG. 6 is an example of a password input screen according to Embodiment 1. When the supervisor causes the control section 261 to start a parental control, the supervisor inputs an arbitrary password to the operating section 116 at first. After inputting the password, the supervisor sets various settings relating to the parental control described hereinafter and the parental control is started.

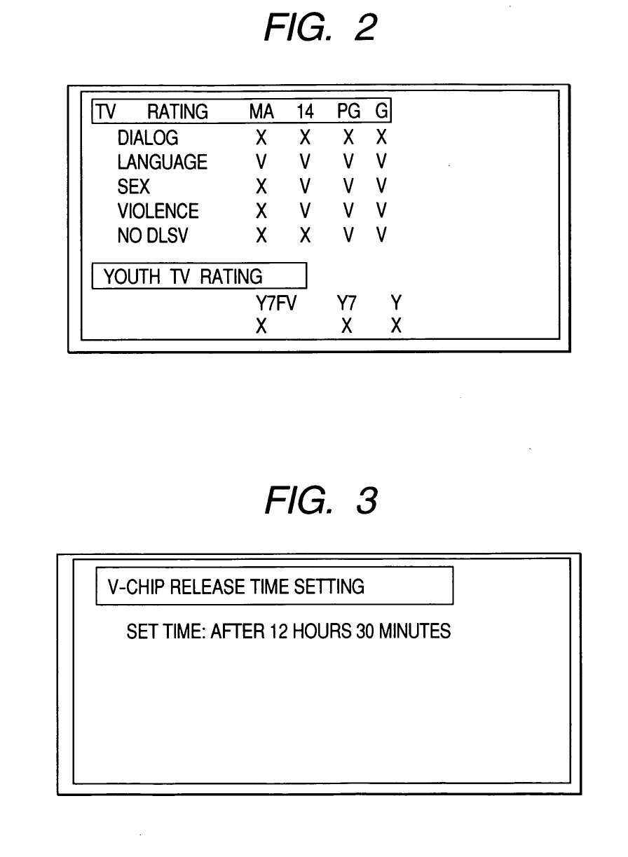

FIG. 2 is an example of a parental control set screen according to Embodiment 1. Two title rows of “TV RATING” and “YOUTH TV RATING” are shown. Two ratings of a general audience rating and a youth rating are exemplified as the full contents in the rating system for television.

In the TV RATING section, columns of MA, 14, PG, and G correspond information about levels such as an adult, 14 or older, unsuitable for children, and general audiences, respectively. Also, in intersection points between categories in respective rows and the levels, V represents a state that a corresponding person can watch the contents and X represents a state that a corresponding person cannot watch the contents.

An expression “NO DLSV” on the lowest row in the TV RATING section corresponds to the case where only the level such as G, MA, or the like is sent without the category information to be set given on four upper rows.

In the YOUTH TV RATING section, columns of Y7FV, Y7, and Y correspond to information about levels such as the children of seven years old or older and program including violent picture of animation, 7 or older, suitable for all children. No category classification of VSLD is shown.

These rating information consist essentially of data of several bits, and are received as the packet of a several-byte format like teletext during VBI (Vertical Blank Interval) and decoded normally by the tuner. Also, normally a control section performs a control by the rating information, but it may be possible to employ such a configuration that the above function may be provided to a signal processing section or a tuner.

FIG. 3 is a display example of a time set screen according to Embodiment 1. FIG. 3 shows an example applied to set a parental control release time (set time) and the supervisor sets that the parental control release time is after 12 hours 30 minutes. In order to display a set screen, the interactive MENU display for the supervisor may be provided at a previous stage.

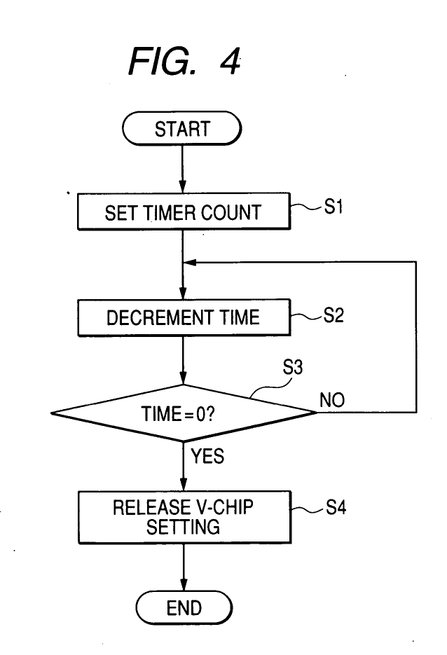

FIG. 4 is a process flowchart of an example of a timer decrement according to Embodiment 1. The set time being set as shown in FIG. 3 is decremented. In block S1, a positive timer count value, in the device, corresponding to the set time is set in the timer 247bthrough the signal processing section 247 based on the instruction from the control section 261. In block S2, the timer count value is decremented in accordance with a clock in the signal processing section 247. In block S3, when this timer count value becomes zero, the timer 247b is stopped and the process goes to block S4. In contrast, when the timer count value does not become zero yet, the process goes back to block S2. In block S4, the timer 247b informs to the signal processing section 247 that this timer count value has become zero. The signal processing section 247 releases the setting of the parental control, that is, restores the video signal output to the graphics processing section 254 and restarts the audio signal output to the audio processing section 255, and outputs to the control section 261 that the timer count value has become zero. Thus, a series of processes are over. The timer 247b is incorporated in the signal processing section 247.

Meanwhile, while the timer count value does not zero, the supervisor can release the parental control by inputting a password.

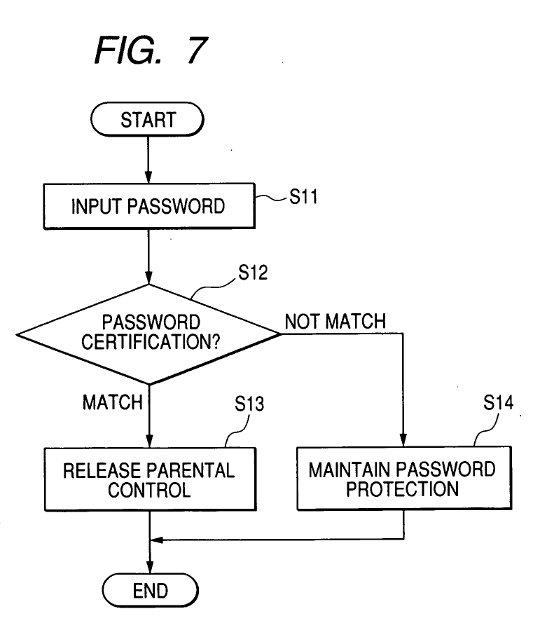

FIG. 7 is a process flowchart of an input of the password when a parental control is performed. In block 11, a password is inputted in the operating section 116 during the parental control being performed. In block 12, the control section 261 determines whether the inputted password at this time is match with the password inputted at the start of the parental control. In block 13, when the inputted password at this time is match with the password inputted at the start of the parental control, the control section 261 releases the parental control although the timer count value does not zero. On the other hand, in block 14, when the inputted password at this time is different from the password inputted at the start of the parental control, the parental control continues. That is, the parental control is protected by the password inputted at the start of the parental control. That is, the control section 261 releases the password protection by a password inputted by a supervisor or according to the time counted by the timer 247b and releases the parental control under the password protection.

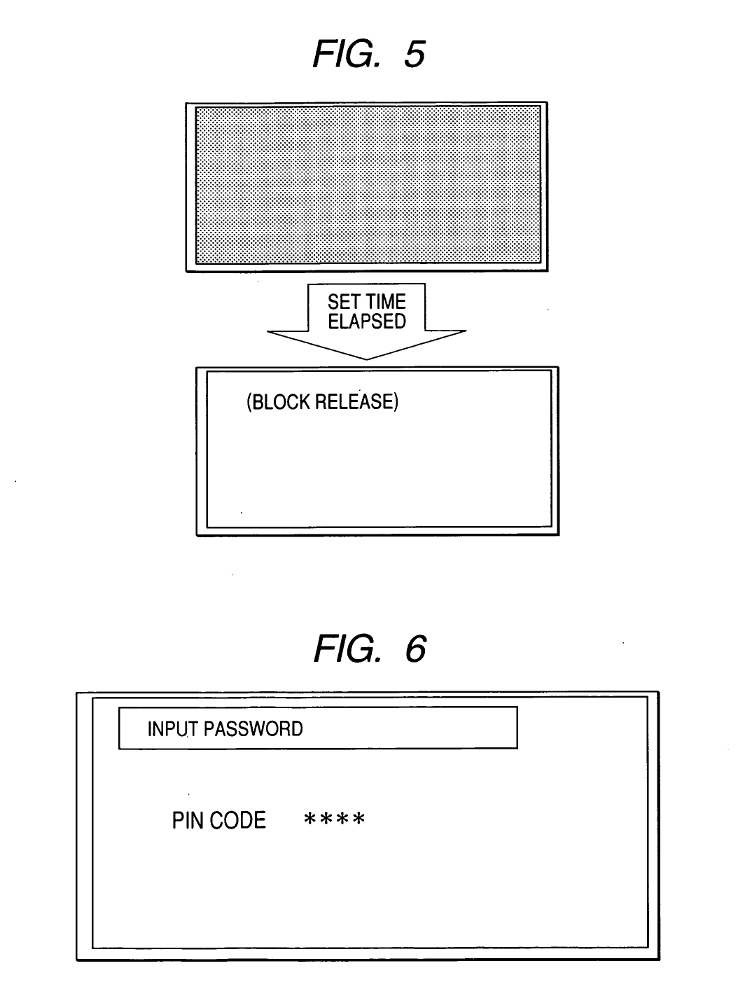

FIG. 5 is an example when the parental control is released after the time has elapsed or by the input of the password. When the control section 261 receives from the signal processing section 247 that the timer count value has become zero as soon as the processes in FIG. 4 is over after the set time set by the supervisor in FIG. 3 has elapsed or the parental control is released by inputting the password, the control section 261 causes the OSD signal generating section 257 to eliminate the block display. In this case, after the supervisor performs the time setting in FIG. 3, the block display (V-CHIP BLOCKED) is started when the control section 261 causes the OSD signal generating section 257 to display such display on the video display device 114 through the graphics processing section 254 and the video processing section 258.

The setting of the parental control is performed in the video audio display device by inputting a password. In order to release the setting of the parental control again, the supervisor must input the password once again. Suppose that the supervisor sets the parental control when the supervisor goes out while leaving the child, the supervisor has to release the parental control by inputting the password when the supervisor comes back home. When the password is set such that the password is not broken by the child, in some case the supervisor will forget the password.

According to the embodiment, in the case where the setting of the parental control is given for a necessary time only to apply the parental control, such setting of the parental control is cleared as soon as the set time elapsed. No problem is caused even when the supervisor forgets the password used normally to release the parental control. Troublesome operations used to input the releasing password every time are not required of the supervisor.

[Embodiment 2]

Embodiment 2 of the video audio display device according to the present invention will be explained with reference to FIG. 1 and FIG. 3 to FIG. 5 hereinafter. Explanation of the portions common to Embodiment 1 will be omitted herein.

The DVD player for supplying the video image of the movie, and the like are contained in respective devices connected to the LAN terminal 122. A scheme used to set the corresponding movie rating system will be given as follows.

There are information about levels consisting of G (General Audiences, general object), PG (Parental Guidance Suggested, there are portions unsuitable for the children and the guardian's decision is needed), PG-13 (Parents Strongly Cautioned, there are portions unsuitable for the children 13 or younger and the guardian's decision is needed), R (Restricted, the youth 17 or younger must be accompanied by the guardian), and NC-17 (No one 17 and under admitted, the youth 17 or younger is inhibited (so-called “X-Rated”)). The category classification as in the television program rating system is not given.

The above embodiments are concerned with the product that is used in the video audio (broadcast program video and video image) watching device and has the detecting device that can detect the rating information of the parental control. The user sets a set time of the parental control by using MENU, or the like. The controller counts a time, and the setting of the parental control is released. The user is not needed to release the setting of the parental control required by inputting the password once again. Also, there is no need to worry about the password even if the user forgets such password. In addition, the parental control is protected by the password in the embodiments, various techniques, such as biometrics and IC card, in which a supervisor is certified may be used for protecting the parental control.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video audio display device comprising:
a receiving section that receives a broadcast program to output an audio signal and a video signal, the broadcast program including rating information;
a speaker unit that receives the audio signal and generates a sound according to the audio signal;
a display unit that receives the video signal and displays an image according to the video signal;
a rating read unit that reads the rating information of the broadcast program;
a block section that blocks a generation of the sound and a display of the image based on the rating information;
a timer that counts a time; and
a control section that release a parental control to block the generation of the sound and the display of the image based on the rating information according to the time counted in the timer.

2. The video audio display device according to claim 1, further comprising an operating section that receives a first password inputted by a user,
wherein the parental control is started after the user inputs the first password, and
wherein the parental control is protected by the inputted first password.

3. The video audio display device according to claim 2, wherein the control section releases a password protect of the parental control to release the parental control according to the time counted in the timer.

4. The video audio display device according to claim 2,
wherein the operating section receives a second password while the parental control is performed,
wherein the control section determines whether the second password is match with the first password, and
wherein when it is determined that the second password is match with the first password, the control section releases a password protect of the parental control to release the parental control.

5. The video audio display device according to claim 1, further comprising a setting section that sets a count time to be counted in the timer.

6. The video audio display device according to claim 1, wherein the control section releases the parental control when the control section determines that a counting in the timer is over.

7. A video audio display device comprising:
an output unit that obtains a video content and outputs a video signal and an audio signal, the video content including rating information;
a speaker unit that receives the audio signal and generates a sound according to the audio signal;
a display unit that receives the video signal and displays an image according to the video signal;
a rating read section that reads the rating information;
a block section that blocks a generation of the sound and a display of the image based on the rating information;
a timer that counts a time; and
a control section that releases a parental control to block the generation of the sound and the display of the image based on the rating information by the time counted in the timer.

8. The video audio display device according to claim 7, further comprising an operating section that receives a first password inputted by a user,
wherein the parental control is started after the user inputs the first password, and
wherein the parental control is protected by the inputted first password.

9. The video audio display device according to claim 8, wherein the control section releases a password protect of the parental control to release the parental control according to the time counted in the timer.

10. The video audio display device according to claim 8,
wherein the operating section receives a second password while the parental control is performed,
wherein the control section determines whether the second password is match with the first password, and
wherein when it is determined that the second password is match with the first password, the control section releases a password protect of the parental control to release the parental control.

11. The video audio display device according to claim 7, further comprising a setting section that sets a count time to be counted in the timer.

12. The video audio display device according to claim 7, wherein the control section releases the parental control when the control section determines that a counting in the timer is over.

13. A video audio display control method comprising:
receiving a broadcast program to output an audio signal and a video signal, the broadcast program including rating information;
receiving the audio signal and generating a sound according to the audio signal;
receiving the video signal and displaying an image according to the video signal;
reading the rating information of the broadcast program;
blocking a generation of the sound and a display of the image based on the rating information;
counting a time from the start of the blocking; and
releasing a parental control to block the generation of the sound and the display of the image based on the rating information according to the time counted in the timer.
